(19) United States
(12) Patent Application Publication
(10) Pub. No.: US 2025/0104900 A1
(43) Pub. Date: Mar. 27, 2025

(54) SUPPRESSOR CHOKE CORE, SUPPRESSOR CHOKE COMPRISING SUCH A SUPPRESSOR CHOKE CORE AND METHOD FOR FORMING A SUPPRESSOR CHOKE CORE

(71) Applicant: SUMIDA COMPONENTS & MODULES GMBH, Obernzell (DE)

(72) Inventor: Jens SCHÜLTZKE, Passau (DE)

(73) Assignee: SUMIDA COMPONENTS & MODULES GMBH, Obernzell (DE)

(21) Appl. No.: 18/730,621

(22) PCT Filed: Jan. 20, 2023
(86) PCT No.: PCT/EP2023/051356

§ 371 Date: Jul. 19, 2024

(30) Foreign Application Priority Data
Jan. 20, 2022 (DE) 10 2022 101 327.8

(51) Int. Cl. H01F 27/26; H01F 41/02

(52) U.S. Cl. CPC H01F 27/26; H01F 41/0206

(57) ABSTRACT

The present disclosure describes a suppressor choke core, a suppressor choke including such a suppressor choke core, and a method for providing a suppressor choke core. A suppressor choke core may include at least two hollow-cylindrical core elements, with one of the hollow-cylindrical core elements being arranged successively, at least in part, in another of the hollow-cylindrical core elements, and the hollow-cylindrical core elements being permanently connected to one another so that a ferrite pipe core is formed.

### CROSS-REFERENCE TO RELATED APPLICATIONS

The present application is the U.S. national phase of PCT Application No. PCT/EP2023/051356, filed on Jan. 20, 2023, which claims priority to German Patent Application No. DE102022101327.8, filed on Jan. 20, 2022, the disclosures of which are hereby incorporated herein by reference in their entireties.

### TECHNICAL FIELD

The present disclosure is directed to a suppressor choke core, a suppressor choke comprising such a suppressor choke core and a method for forming a suppressor choke core.

### BACKGROUND

Chokes are generally used as coils or inductors in electrical engineering to limit currents in electrical lines, to temporarily store energy in the form of a magnetic field, to adjust the impedance of a circuit to the desired degree or they are provided as filters. In contrast to transformers or resonant circuit inductors, chokes are usually connected in series with other components or consumers.

The magnetic core of chokes is usually made of a soft magnetic material. This increases the inductive resistance of the choke and allows a reduction in the size of the choke. Soft magnetic materials are usually understood to be materials that can be easily magnetized in a magnetic field, such as ceramic materials in the form of ferrite based on a metal oxide, for example manganese-zinc ferrites or nickel-zinc ferrites.

A suppressor choke is a type of choke that is used to reduce high-frequency interference signals by means of a high inductive resistance of the chokes, while direct current and low-frequency currents are not or only slightly affected. In a particularly simple form, a suppressor choke is formed by a toroidal core that is pushed onto a cable or provided by a so-called split ferrite. For interference suppression in data bus systems, there are also numerous variants of high-frequency coils for interference suppression in the form of perforated, cylindrical or flat ferrite cores, which can be split as split ferrites. These ferrite cores are clipped or threaded onto the current-carrying conductor or the ferrite core is wrapped around the current-carrying conductor. However, cores that are clipped onto a busbar or chokes with several windings are also known.

In the applications described above, it is desirable to maintain a desired performance (i.e. filter effect and impedance) over a wide frequency range. However, broadband performance is limited by eddy currents. Even if an attempt is made to reduce eddy current losses of a solid core by measures in which the smallest possible ratio of a flowed-through ferrite core area relative to the circumference is provided, this results in a limitation of the broadband performance in such a case as well. In particular, this represents an approach in which, instead of a solid ferrite tube core, a ferrite tube core configured as a layered core is formed from several tube core sections which are lined up one behind the other along a longitudinal direction of the ferrite tube core (corresponds to a direction perpendicular to azimuthal and radial directions given in cylindrical coordinates of the ferrite tube core). As will be explained below with reference to FIG. 5, this approach does not offer a real solution, since a reduction in eddy current losses also limits the broadband performance.

Furthermore, it is necessary for layered cores formed as sintered cores to continue to join the individual tube core sections by sharpening and gluing in a form-fitting manner. These processing steps contribute to complex manufacturing processes and therefore increase the manufacturing costs of the corresponding cores.

### SUMMARY

It is therefore an object of the disclosure to provide a ferrite tube core as a suppressor choke core with a desired broadband performance, which can be manufactured in a simple manner. It is also an object of the disclosure to provide a suppressor choke which has a desired broadband performance while being easy to manufacture. Furthermore, it is an object of the disclosure to provide a method for forming a ferrite tube core as a suppressor choke core, which allows simple manufacture of a ferrite tube core with a large broadband performance.

The above-mentioned problems are solved in various aspects by a suppressor choke core according to independent claim 1, a suppressor choke according to independent claim 7 and a method according to independent claim 9. Preferred configurations of the suppressor choke core are defined in dependent claims 2 to 6, while a preferred configuration of the suppressor choke according to independent claim 7 is defined in dependent claim 8 and preferred configurations of the method according to independent claim 9 are defined in dependent claims 10 to 15.

In a first aspect of the present disclosure, a suppressor choke core is provided. In illustrative embodiments of the first aspect, the suppressor choke core comprises at least two hollow-cylindrical core elements, wherein successively one of the hollow-cylindrical core elements is at least partially arranged in another of the hollow-cylindrical core elements and the hollow-cylindrical core elements are permanently connected to each other so that a ferrite tube core is formed. The ferrite tube core can be formed from a highly permeable material, for example the hollow-cylindrical core elements can have a magnetic permeability u of at least 2000, for example the relative permeability μᵣ can be >2000. This provides a ferrite tube core that has a preferred broadband performance and is easy to manufacture. This ferrite tube core can provide in a filter with preferred filtering efficiency and impedance over a wide frequency range, wherein eddy currents are advantageously suppressed. In specific illustrative examples, one of the hollow-cylindrical core elements may be completely enclosed by the other. In the case of hollow-cylindrical core elements each provided as a hollow cylinder, these can be successively arranged concentrically to one another. In illustrative examples herein, the ferrite tube core may have exactly two hollow-cylindrical core elements.

The suppressor choke core according to the first aspect provides the possibility of suppressing by providing the largest possible broadband reactance for an inductance with this ferrite tube core. Here, the inventors recognized that eddy current losses in the ferrite core can be limited without limiting the broadband performance of an inductance with this ferrite tube core. According to eddy current principles, the ratio of the flowed-through ferrite core area relative to the circumference should be as low as possible for small losses. A small-area rectangle with a large aspect ratio, however, would be preferred to a circular area. This is achieved by dividing the ferrite cores and inserting them into each other like sleeves to create an onion structure. In specific illustrative examples, the cores inserted into one another to form an onion structure can be sintered together for a ferrite tube core in accordance with the first aspect, so that a high-resistance form-fitting connection is created.

According to the first aspect, the advantage of the suppressor choke core results in the fact that a desired broadband performance can already be achieved with a small degree of subdivision of the core, which enables a relatively simple manufacturing process, since, for example, compared to a known core with a layered structure, additional processing steps can be dispensed with, such as additional sharpening and gluing steps after sintering of core layers. This reduces the manufacturing costs of ferrite tube cores according to the first aspect.

In some illustrative embodiments of the first aspect, the at least two hollow-cylindrical core elements may be sintered and/or glued together. The sintering and/or gluing forms a separating layer between the core elements corresponding to a dispersion region and/or a glue joint between the core elements. This separating layer or joint provides a magnetic resistance between the core elements, which leads to an improvement in broadband performance.

In some illustrative embodiments of the first aspect, the core elements can be formed from the same material. This provides the advantage that the ferrite tube core has magnetic properties with low tolerances, as the hollow-cylindrical core elements are formed under low tolerances. This is due to the fact that, with regard to shrinkage of the core elements during manufacture of the core elements using the same materials, the core elements exhibit similar shrinkage and this can therefore be neglected. Alternatively, the core elements can be made of different materials so that the magnetic properties of the ferrite tube core can be adapted using core elements made of different materials.

In some illustrative embodiments of the first aspect, the ferrite tube core may be configured such that it has an impedance of greater than or equal to 580 Ω/m, preferably greater than or equal to 600 Ω/m and further preferably greater than or equal to 700 Ω/m in the range of 10 kHz to 100 MHz. This represents a preferred impedance for high frequencies in the range from 10 kHz to 100 MHz. This means that a certain impedance can be achieved over a wide frequency range even with a small number of hollow-cylindrical core elements, for example even with a ferrite tube core with exactly two hollow-cylindrical core elements.

In some illustrative embodiments of the first aspect, the ferrite tube core may be configured such that it has an impedance of greater than 390 Ω/m, preferably greater than 400 Ω/m, in the range of 5 kHz to 100 MHz. This is a preferred impedance for high frequencies in the range from 5 kHz to 100 MHz.

In a second aspect of the present disclosure, there is provided a suppressor choke for suppressing high frequency interference. In illustrative embodiments of the second aspect, the suppressor choke comprises a suppressor choke core according to the first aspect and at least one current conductor passing through the ferrite tube core. This provides a suppressor choke which has a preferred broadband performance and can be manufactured in a simple manner.

In illustrative embodiments of the second aspect, the at least one current conductor can comprise a busbar that is passed through the ferrite tube core. This allows the suppressor choke to be preferably used in high frequency applications of busbar systems.

In a third aspect of the present disclosure, a method of forming a suppressor choke core is provided. In illustrative embodiments of the third aspect, the method comprises forming at least two hollow-cylindrical core elements, wherein successively one of the hollow-cylindrical core elements can be arranged in another of the hollow-cylindrical core elements. In this process, at least two hollow-cylindrical core elements are formed, which are configured such that these formed hollow-cylindrical core elements are adapted to be successively arranged in one another. The method further comprises arranging the at least two hollow-cylindrical core elements in an arrangement in which successively one of the hollow-cylindrical core elements is arranged in another of the hollow-cylindrical core elements, and permanently fastening the at least two hollow-cylindrical core elements in the arrangement so that a ferrite tube core is formed. This method allows a simple manufacture of a suppression choke core with preferred broadband performance. In specific illustrative examples, the hollow-cylindrical core elements can be arranged successively to one another in a concentric arrangement. In illustrative examples herein, the manufactured ferrite tube core may be formed of a highly permeable material, for example the hollow-cylindrical core elements may have a magnetic permeability μ of at least 2000, i.e. the relative permeability μᵣ>2000. This appropriately manufactured ferrite tube core may provide in a filter with preferred filtering effect and impedance over a wide frequency range, wherein eddy currents are preferably suppressed.

In illustrative examples of the third aspect, the ferrite tube core can have exactly two hollow-cylindrical core elements. This means that a certain impedance can be achieved over a wide frequency range even with a small number of hollow-cylindrical core elements, for example even with a ferrite tube core with exactly two hollow-cylindrical core elements. For example, the ferrite tube core manufactured according to the third aspect can have an impedance of greater than or equal to 580 Ω/m, preferably greater than or equal to 600 Ω/m and more preferably greater than or equal to 700 Ω/m in the range from 10 kHz to 100 MHz. This represents a preferred impedance for high frequencies in the range from 10 kHz to 100 MHz. Furthermore, the ferrite tube core can have an impedance of greater than 390 Ω/m, preferably greater than 400 Ω/m, in the range from 5 kHz to 100 MHz. This is a preferred impedance for high frequencies in the range from 5 kHz to 100 MHz.

In some illustrative embodiments herein, forming at least two hollow-cylindrical core elements may comprise providing the at least two hollow-cylindrical core elements as pressed green compacts, and permanently fastening may comprise sintering the green compacts. As a result, the ferrite tube core can be formed in a simple manner based on the green compacts as pressed parts by sintering, wherein the core elements are joined together by sintering and the ferrite tube core can thus be manufactured as a compact body in a simple manner in just a few steps. In this case, a separating layer is provided by dispersion boundaries between sintered core elements.

In some alternative illustrative embodiments of the third aspect, the forming of the at least two hollow-cylindrical core elements may comprise providing the at least two hollow-cylindrical core elements as pressed green compacts and subsequently sintering the green compacts, and the permanent fastening may comprise gluing the at least two hollow-cylindrical core elements together or successively pressing the green compacts together. In this context, the core elements can each be provided as sintered ferrite core elements in the form of compact core elements, which can then be attached to each other in a gluing process by means of a glue joint. This allows a desired separating layer to be set through the glue joint. A thickness of a separating layer can depend on the specific resistance of a material of the separating layer (e.g. air, epoxy resin/adhesive, metal oxide) and a barrier layer resistance and can be selected appropriately. For example, in illustrative examples, the separating layer can have a barrier layer resistance of at least 1*10⁶Ω or at least 1*10² Ωm. For example, a thickness of the separating layer can be at most 5% of a radial thickness of a ferrite core element. Alternatively, during successive pressing of the green compacts, a first green compact can be formed from a first material, the first green compact can be embedded in a second material and the green compact embedded in the second material can be pressed, so that successively encased green compacts are formed.

In some illustrative configurations of these alternative illustrative embodiments of the third aspect, the method may further comprise finishing the at least two hollow-cylindrical core elements after sintering by milling the at least two hollow-cylindrical core elements into a desired shape. In this way, tolerances in the geometric dimensions of the core elements can be kept very low by milling.

In some illustrative embodiments of the third aspect, the at least two hollow-cylindrical core elements may be formed of different material and the method may further comprise performing sintering in accordance with a predetermined shrinkage of batches of hollow-cylindrical core elements and/or adapting standing and cooling times during sintering to reduce distortion. This allows the geometric tolerances of the core elements to be kept to a minimum during manufacture, since, on the one hand, shrinkage that occurs during the sintering of dissimilar materials is determined in advance and can then be taken into account during the sintering process in such a way that sintering parameters (such as temperature, oxygen content and duration of the sintering process) can be examined in advance with regard to the shrinkage caused by them. The optimum sintering parameters for a sintering process can thus be identified in advance, at which shrinkage can be minimized. Additionally or alternatively, distortion caused by temperature and cooling times can be avoided by coordinating the temperature and cooling times during sintering with the aim of preventing or minimizing any distortion that occurs during sintering.

In other illustrative embodiments and alternative embodiments to the immediately preceding embodiments, the at least two hollow-cylindrical core elements may be formed of the same material and the method may further comprise adapting temperature and cooling times during sintering to reduce distortion.

In some illustrative embodiments, the method according to the third aspect may be used to manufacture the suppressor choke core according to the first aspect. Thus, in at least one illustrative embodiment of the third aspect as described above, in a particular example, the method according to the third aspect is carried out to manufacture a suppressor choke core according to one of the illustrative embodiments of the first aspect described above. Furthermore, in an illustrative application of the method according to the third aspect, the suppressor choke according to the second aspect can also be manufactured accordingly, wherein furthermore, after manufacturing the suppressor choke core, at least one current conductor is passed through the ferrite tube core or the ferrite tube core is clipped onto at least one current conductor.

In the first to third aspects as described above, a suppressor choke core may be provided that may have a high permeability and/or a substantially constant high permeability in at least some illustrative embodiments of at least one of the first to third aspects described above. For example, a permeability of greater than 6000 can be provided in a frequency range up to 20 kHz, for example μᵣ can be >6000. For example, a high permeability in this frequency range can be essentially maintained in a highly permeable region of the ferrite tube core. Essentially, the permeability of the ferrite tube core can be essentially constant in the range 1 kHz to 20 kHz, so that the permeability in the frequency range up to 10 kHz can be greater than 9000, e.g. μᵣ can be >9000. Thus, a suppressor choke provided according to the second aspect can show a corresponding course of permeability in this frequency range. Furthermore, the permeability in the frequency range up to 50 kHz is greater than 2000, preferably greater than 3000, more preferably greater than 4000, e.g. μᵣ>2000, preferably μᵣ>3000, more preferably μᵣ>4000.

### BRIEF DESCRIPTION OF THE DRAWINGS

Further preferred effects and features of the present disclosure, as illustrated above in the various aspects, will become apparent from the following detailed description of the accompanying figures, wherein:

FIG. 1 shows a schematic perspective view of a known ferrite tube core;

FIG. 2 shows a schematic perspective view of another known ferrite tube core;

FIG. 3 shows a schematic perspective view of a ferrite tube core according to illustrative embodiments of the disclosure;

FIG. 4 shows a schematic perspective view of a suppressor choke according to various illustrative embodiments of the disclosure;

FIG. 5 shows schematically a relationship between magnetic permeability and frequency in a diagrammatic representation; and

FIG. 6 shows schematically a relationship between impedance and frequency in a diagrammatic representation.

### DETAILED DESCRIPTION

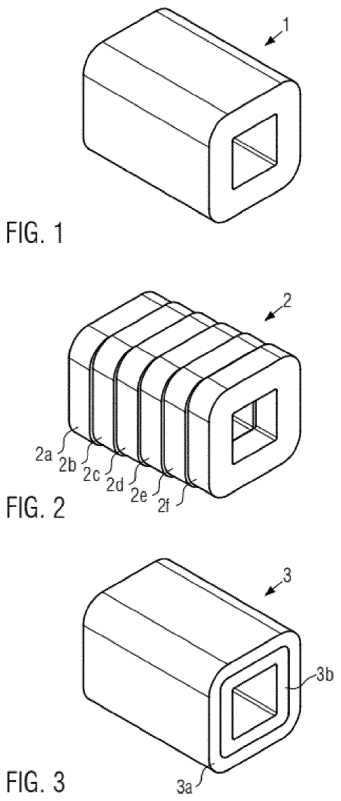

In the following description of FIGS. 1 and 2, known ferrite tube cores are shown, which are contrasted in the further course of the description with a ferrite tube core according to illustrative embodiments of the present disclosure.

FIG. 1 shows a known ferrite tube core 1 in the form of a solid core made of a ferrite material. The ferrite tube core 1 is made of a ferrite material.

FIG. 2 shows another known ferrite tube core 2, which is formed from individual core elements 2a to 2f arranged one behind the other in a layered stacking arrangement. The core elements 2a to 2f are formed congruently with each other.

FIG. 3 shows a schematic perspective view of a suppressor choke core, which is configured as a ferrite tube core 3 according to various illustrative embodiments of the disclosure. The ferrite tube core 3 comprises two core elements 3a and 3b, which are arranged concentrically to each other. This means that the core elements 3a and 3b are formed so that they can be arranged in a concentric arrangement with respect to each other. In particular, an inner diameter of the core element 3a is essentially equal to an outer diameter of the core element 3b. However, this is not a limitation and the inner diameter of the core element 3a can also be larger than the outer diameter of the core element 3b in order to form a predetermined air gap between both core elements 3a and 3b.

Although the illustration in FIG. 3 shows only two core elements, this is not a limitation of the present disclosure and alternatively any number of hollow-cylindrical core elements, in particular 3, 4, 5 or more than 5 core elements, may be used to form a ferrite tube core.

In some illustrative embodiments, each of the hollow-cylindrical core elements 3a and 3b is formed as a ferrite core element or compact body. In other words, each of the hollow-cylindrical core elements 3a and 3b may be individually sintered. Optionally, at least one of the core elements 3a and 3b can then be reworked, for example to be shaped to a desired form using a milling machine, wherein manufacturing tolerances can be reduced in the manufacture of the ferrite tube core 3. After sintering and optional further processing, the hollow-cylindrical core elements 3a and 3b can be attached to each other in a gluing process by means of a glue joint. Alternatively, the hollow-cylindrical core elements 3a and 3b can be attached to each other by clamping after sintering and optional further processing. This ensures that the hollow-cylindrical core elements 3a and 3b are permanently attached to each other. All or individual hollow-cylindrical core elements can also be formed from several individual partial ring elements, which can be glued or sintered to form a hollow-cylindrical core element.

Alternatively, the hollow-cylindrical core elements 3a and 3b may initially be provided as green compacts, wherein these green compacts are formed by a dry or wet pressing of ferrite powder into a desired shape corresponding to a shape of the hollow-cylindrical core elements 3a and 3b. The pressing can be a one-sided pressing, two-sided pressing or isostatic pressing. These green compacts can then be arranged concentrically one inside the other. A sintering process can then be carried out, wherein at the end of the sintering process the hollow-cylindrical core elements 3a and 3b are provided as core elements sintered together. In this process, a dispersion boundary occurs between the hollow-cylindrical core elements 3a and 3b, which results from the fact that during sintering, a ferrite material is dispersed from a green compact corresponding to one of the hollow-cylindrical core elements 3a and 3b into the other green compact corresponding to the other of the two hollow-cylindrical core elements, thereby creating a more or less sharp dispersion boundary between the two green compacts at an interface between them. In this context, a dispersion boundary is understood to be a disperse phase of two different materials that is created during pressing in a multi-layer process. In a multi-layer process, two different materials are placed in a mold, separated by an inlay/cavity. The materials are mixed when they are removed. In general, dispersion limits are undesirable and should be kept as low as possible in the manufacturing process. In some illustrative examples, a ratio of dispersion boundaries relative to wall thickness can be less than or equal to 1:100.

In some illustrative embodiments, a suppressor choke core in the form of a ferrite tube core may be formed as follows. Initially, a first tubular core green compact (corresponding to a first hollow-cylindrical core element) having an outer ring diameter may be provided. A first material can be pressed in a first mold to form the first tube core green compact with the first outer ring diameter. The first tube core green compact can be inserted into a larger second mold so that the second mold is significantly larger than the first tube core green compact and further space remains in the second mold around the first tube core green compact, which can be filled with material. The first material may, in some illustrative examples herein, be different from the second material, although this is not a limitation and the materials may be the same, in particular materials having the same composition, wherein these materials may differ by at least one physical parameter (for example, without limitation, grain sizes may be different). Both materials in the larger second mold are pressed together so that a ferrite tube core green compact is formed from two successively pressed tube core green compacts. The second material pressed around the first tube core green compact forms a second tube core green compact (corresponding to a second hollow-cylindrical core element). The ferrite tube core green compact can be subjected to further processing, such as a sintering process.

This process described above can be used iteratively, for example, a ferrite tube core green compact can be formed after at least one repetition of the process steps described above of arranging a first tube core green compact in a larger mold, filling space around the first tube core green compact arranged in the larger mold with further material and pressing in the larger mold, and so on. The resulting ferrite tube core green compact can in turn be iteratively inserted as a further tube core green compact into a larger iteratively following further mold, filling a material around a space around the further tube core green compact arranged in this further mold and carrying out a pressing process, etc.

A suppressor choke core can thus be provided with hollow-cylindrical core elements arranged successively one inside the other, wherein successively one hollow-cylindrical core element is encased or completely surrounded by another hollow-cylindrical core element. A hollow-cylindrical core element which is encased by another hollow-cylindrical core element represents an inner core element, wherein the inner core is incumbent on the subdivision of the wall thickness and thereby limits the eddy currents and thus leads to the improved broadband performance.

In some illustrative embodiments, at least one barrier layer can be formed by a metal oxide layer with high R_{spez} (for example >10 Ωm) or one or more insulators (air gap, adhesive).

In some illustrative embodiments, dispersion limit areas can be formed in the multilayer process in a ratio of dispersion limit area to wall thickness of at least 1:10 for a wall thickness>5 mm. In the case of separately pressed green compacts, dispersion limit areas in a ratio of 1:100 are possible.

In an alternative manufacturing process, materials for the different core elements 3a and 3b can be filled into a chamber of a mold, wherein the chamber is divided by a cavity. After the chamber has been filled with the materials for the core elements, the cavity can be removed and the material in the chamber can be pressed. In this process, it is also possible to apply a temperature during pressing so that sintering can be carried out at the same time. Alternatively, a sintering treatment can be carried out at a later stage after pressing. The pressing process can involve one-sided pressing and/or two-sided pressing and/or isostatic pressing.

According to some illustrative embodiments, the hollow-cylindrical core elements 3a and 3b may be formed from the same material. Alternatively, the hollow-cylindrical core elements 3a and 3b may be formed from different materials. Ferrite materials, as are known for use in chokes, in particular suppressor chokes, can be used as the material for forming the core elements 3a and 3b.

In some illustrative embodiments, materials may have a permeability μi of at least 2000 and/or a specific resistance of at most 5 Ωm. For example, a suitable material can be selected in such a way that permeability is weighed against resistivity. In this case, an intended increase in impedance at high frequencies can be achieved by selecting a relatively increased permeability and a simultaneously reduced specific resistance. Exemplary materials are Fi340, Fi360, Fi410, Fi412, Fi415.

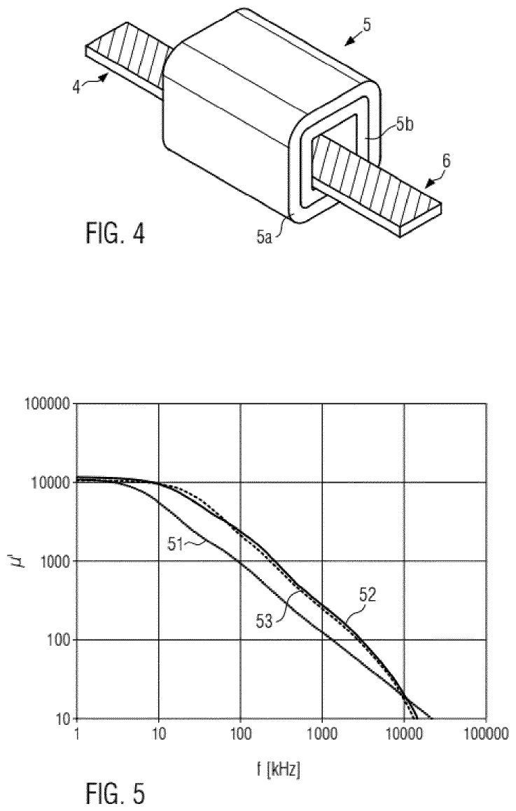

FIG. 4 shows a suppressor choke 4 according to some illustrative embodiments in a perspective view. The suppressor choke 4 comprises a suppressor choke core in the form of a ferrite tube core 5 with hollow-cylindrical core elements 5a and 5b, which are arranged concentrically one inside the other, and a current conductor 6, which is passed through the ferrite tube core 5. According to the illustration in FIG. 5, the current conductor 6 is a busbar, for example a busbar of a busbar system. As an alternative to the embodiment shown, a wire winding (not shown) can be provided over the ferrite tube core 5 instead of the busbar 6, wherein the wire winding can have a winding number ≥1.

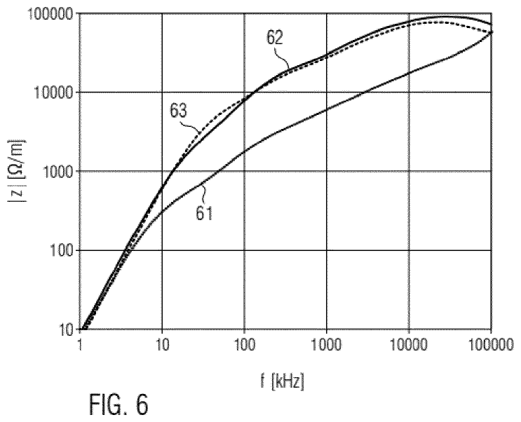

With reference to FIGS. 5 and 6, relationships between a magnet permeability (cf. FIG. 5) and an impedance (cf. FIG. 6) with respect to a frequency of a current through a current conductor of a suppressor choke with a ferrite tube core, for example the suppressor choke 4 of the description above, as provided by the inventor, are shown. In connection with FIGS. 5 and 6, suppressor chokes with known ferrite tube cores are compared with a suppressor choke with a ferrite tube core according to the disclosure.

The diagrams in FIGS. 5 and 6 refer to material properties (complex permeability μ′ specific resistance |ż|). The volume, geometry and absolute size of the cores are not necessary for the illustration in FIGS. 5 and 6; rather, only the ratio of the wall thicknesses to each other and the absolute wall thickness can be important. The measurements in FIGS. 5 and 6 were carried out in the small-signal range (<0.5 mT), with currents and voltages resulting from the flux density of less than 0.5 mT and from the shape characteristics and winding of the core, wherein the same principle can also be applied to large-signal measurements.

FIG. 5 shows a logarithmic scale diagram in which a frequency in units of kHz is plotted against a magnetic permeability. This shows that a graph 51 represents a relationship between magnetic permeability and frequency for a solid core corresponding to the solid core 1 of FIG. 1. In comparison, a graph 52 shows a plot of the relationship between magnetic permeability and frequency for a known layered core corresponding to the ferrite tube core 2 of FIG. 2. As can be seen here, the magnetic permeability of the layered core is greater than that of the solid core over a wide frequency range. This situation was described above in connection with known layered cores, which can limit the occurrence of eddy currents compared to solid cores, as these layered cores have the smallest possible ratio of a ferrite core area through which current flows to the circumference; however, they do not exhibit optimum broadband performance, as can be seen from graph 52.

Furthermore, a graph 53 is drawn in FIG. 5, which shows a relationship between magnetic permeability and frequency for a ferrite tube core according to the disclosure, in particular a ferrite tube core corresponding to the ferrite tube core 3 of FIG. 3. In this context, the magnetic behavior of the ferrite tube core corresponding to graph 53 is comparable to the layered core corresponding to graph 52. Compared to the known ferrite cores in graphs 51 and 52, the ferrite tube core corresponding to graph 53 achieves a high magnetic permeability over a large frequency range with a simultaneously simple structure of the ferrite core (two core elements in the ferrite tube core 3 of FIG. 3 compared to six core elements in the ferrite tube core 2 of FIG. 2). Compared to a layered core, as shown in FIG. 5 with regard to its magnetic permeability using graph 52, the ferrite tube core 3 in FIG. 3 has a comparatively lower degree of subdivision compared to the layered core and is therefore cost-effective to manufacture. The structure of the ferrite tube core 3 in FIG. 3 thereby offers a small-area rectangle with a large aspect ratio and is thus advantageous in terms of suppressing eddy current losses compared to the known layered core structure, while at the same time also providing preferred broadband performance. According to the inventors' knowledge, this advantage was achieved by dividing the ferrite core 3 of FIG. 3 into the core elements 3a and 3b, which are inserted into each other like sleeves to form an onion structure.

In illustrative embodiments and as shown in FIG. 5, the ferrite tube core 3 of FIG. 3 may have a permeability of greater than 1500 in a frequency range up to 20 kHz, for example μᵣ>1500, so that a high permeability in this frequency range may be substantially maintained in a high permeability range. Essentially, the permeability as shown in FIG. 5 is essentially constant in the range 1 kHz to 20 kHz, so that the permeability in the frequency range up to 10 kHz is greater than 9000, e.g. μᵣ>9000. Furthermore, the permeability in the frequency range up to 50 kHz is greater than 2000, e.g. μᵣ>2000, preferably greater than 3000, e.g. μᵣ>3000, more preferably greater than 4000, e.g. μᵣ>4000. Furthermore, the permeability in the frequency range up to 100 kHz is greater than 2000, e.g. μᵣ>2000 in the frequency range up to 100 KHz.

In some specific illustrative embodiments herein, the core elements 3a and 3b in FIG. 3, which are inserted into each other to form the onion structure of the ferrite tube core 3 in FIG. 3, can be joined together to form a high-impedance positive connection between these core elements. In contrast, a layered structure according to a known layered core, as illustrated by the graph in FIG. 52, requires additional processing after sintering, such as sharpening and gluing, as described above.

With reference to FIG. 6, a graphical representation of a relationship between impedance and frequency is shown for the different ferrite tube cores from FIGS. 1 to 3. Here, a graph 61 represents a relationship between impedance and frequency for a solid core, while a graph 62 represents a relationship between impedance and frequency for a layered core corresponding to the ferrite tube core 2 of FIG. 2, and a graph 63 represents a relationship between impedance and frequency for a ferrite tube core corresponding to the ferrite tube core 3 of FIG. 3. As can be seen from FIG. 6, an impedance for a solid ferrite tube core corresponding to graph 61 is smaller for a large frequency range than an impedance for the ferrite tube cores from FIGS. 2 and 3 corresponding to graphs 62 and 63. In particular, the impedance behavior of the ferrite tube core corresponding to FIG. 3 is similar to the impedance behavior of the ferrite tube core from FIG. 2. However, the preferred impedance behavior corresponding to the graph 63 can already be achieved with a smaller number of core elements, as the ferrite tube core in FIG. 2, for example, shows a layering of six core elements. This represents an increased manufacturing effort, so that a ferrite tube core according to the disclosure achieves a preferred magnetic behavior according to FIGS. 5 and 6 even with a lower manufacturing effort with few core elements. This makes it possible to provide suppressor chokes with improved performance and greater broadband performance in a simplified manner with low manufacturing effort.

With further reference to FIG. 6, the ferrite tube core 3 of FIG. 3 can have an impedance of greater than 580 Ω/m, preferably greater than 600 Ω/m and more preferably greater than 700 Ω/m in illustrative embodiments as measured by the inventor in the range from 10 kHz to 100 MHz. Furthermore, the ferrite tube core 3 of FIG. 3 can have an impedance of greater than 390 Ω/m, preferably greater than 400 Ω/m, in illustrative embodiments as measured by the inventor in the range from 5 kHz to 100 MHz.

In summary, the present disclosure provides ferrite tube cores which are built up from sleeves inserted into each other to form an onion structure and which, with the same degree of subdivision, have a significantly higher broadband performance than, for example, known layered cores. In a concrete non-limiting example, two ferrite tube cores inserted into each other can already have a better broadband performance compared to a ferrite tube core of the same shape with a layered structure of six layers.

In the manufacture of sintered hollow-cylindrical ferrite core elements, the inventors have recognized that tolerances in the dimensions of sintered hollow-cylindrical ferrite core elements are mainly dependent on shrinkage and distortion. Generally, in a sintering process, contact formation and contact growth between neighboring particles of a powder material or green compact to be sintered occurs at an early stage of the sintering process during a period of heating. In an intermediate stage of the sintering process, also known as the “shrinkage stage”, shrinkage rates occur at sintering temperatures (about 80% of a melting temperature) and optionally under the effect of pressure in the sintering process, the maximum of which occurs in the area of isothermal sintering, wherein the shrinkage rates decrease more non-linearly after exceeding the maximum. Subsequently, the sintered body formed in the sintering process reaches the density of a solid body in a final stage with a further decrease in the shrinkage rate, so that a compact body is formed at the end of the sintering process.

For hollow-cylindrical ferrite core elements made of the same material, this means that shrinkage is similar for the same materials and can therefore be neglected for the different core elements with the same material. This leaves only a distortion to be taken into account, which is dependent on the sintering process and can be influenced by the temperature and cooling times.

In the case of hollow-cylindrical ferrite core elements made of several different materials, on the other hand, the hollow-cylindrical ferrite elements are manufactured from different materials, so that the inventors propose to determine the shrinkage of batches in advance in order to optimize the manufacturing process and to take these findings of determined shrinkage values of batches into account during manufacture. Furthermore, the distortion can be influenced to a known extent depending on the sintering process with regard to the cooling times.

In the various embodiments, it has been recognized by the inventors that the broadband performance of ferrite tube cores according to the disclosure depends on a characteristic of the dispersion layer or glue joint between different core elements. In particular, it has been recognized that broadband performance is directly proportional to the resistance in the separating layer. A thickness of the separating layer can be based on the specific resistance of the insulator material (air, epoxy resin/adhesive, metal oxide) and a barrier layer resistance of >1*10⁶Ω or >1*10² Ωm.

1. A suppressor choke core comprising at least two hollow-cylindrical core elements, wherein successively one of the at least two hollow-cylindrical core elements is arranged at least partially in another one of the at least two hollow-cylindrical core elements and the at least two hollow-cylindrical core elements are permanently joined together, so that a ferrite tube core is formed.

2. The suppressor choke core according to claim 1, wherein the at least two hollow-cylindrical core elements are successively arranged concentrically to one another.

3. The suppressor choke core according to claim 1, wherein the at least two hollow-cylindrical core elements are sintered and/or glued together.

4. The suppressor choke core according to claim 1, wherein the at least two hollow-cylindrical core elements are formed from the same material.

5. The suppressor choke core according to claim 1, wherein the at least two hollow-cylindrical core elements are formed of different material.

6. The suppressor choke core according to claim 1, wherein the ferrite tube core has an impedance of greater than 580 Ω/m in the range from 10 kHz to 100 MHz.

7. A suppressor choke for suppressing high-frequency interference, comprising the suppressor choke core according to claim 1 and at least one current conductor which is passed through the ferrite tube core.

8. The suppressor choke according to claim 7, wherein the at least one current conductor comprises a busbar which is passed through the ferrite tube core.

9. A method of forming a suppressor choke core, comprising:
forming at least two hollow-cylindrical core elements, wherein successively one of the at least one hollow-cylindrical core elements is arrangeable in another one of the at least two hollow-cylindrical core elements;
arranging the at least two hollow-cylindrical core elements in an arrangement in which successively the one of the at least two hollow-cylindrical core elements is arranged in the another one of the at least two hollow-cylindrical core elements; and
permanently fastening the at least two hollow-cylindrical core elements in the arrangement.

10. The method according to claim 9, wherein the arranging comprises successively arranging the at least two hollow-cylindrical core elements with respect to each other in a concentric arrangement.

11. The method according to claim 9, wherein the forming of at least two hollow-cylindrical core elements comprises providing the at least two hollow-cylindrical core elements with pressed green compacts and wherein the permanently fastening comprises sintering the green compacts.

12. The method according to claim 9, wherein the forming of at least two hollow-cylindrical core elements comprises providing the at least two hollow-cylindrical core elements as pressed green compacts and a subsequent sintering of the green compacts, and wherein the permanent fastening comprises a gluing of the at least two hollow-cylindrical core elements or a successive pressing of the green compacts.

13. The method according to claim 12, further comprising finishing the at least two hollow-cylindrical core elements after sintering by milling the at least two hollow-cylindrical core elements into a desired shape.

14. The method according to claim 11, wherein the at least two hollow-cylindrical core elements are formed from different material, and wherein the method further comprises performing sintering according to a predetermined shrinkage of batches of hollow-cylindrical core elements and/or adapting standing and cooling times during sintering to reduce distortion.

15. The method according to claim 11, wherein the at least two hollow-cylindrical core elements are formed from the same material, and wherein the method further comprises adapting standing and cooling times during sintering to reduce distortion.

16. The suppressor choke core according to claim 2, wherein the at least two hollow-cylindrical core elements are sintered and/or glued together.

17. The suppressor choke core according to claim 2, wherein the at least two hollow-cylindrical core elements are formed from the same material.

18. The suppressor choke core according to claim 3, wherein the at least two hollow-cylindrical core elements are formed from the same material.

19. The suppressor choke core according to claim 2, wherein the at least two hollow-cylindrical core elements are formed of different material.

20. The suppressor choke core according to claim 3, wherein the at least two hollow-cylindrical core elements are formed of different material.
